(19) United States
(12) Patent Application Publication
(10) Pub. No.: US 2026/0336635 A1
(43) Pub. Date: Oct. 29, 2026

(54) TARGET POSITION PREDICTION METHOD

(71) Applicant: TOYOTA JIDOSHA KABUSHIKI KAISHA, Toyota-shi Aichi-ken (JP)

(72) Inventors: Yoshiyuki USUI, Utsunomiya-shi Tochigi-ken (JP); Kohtaro TANAKA, Sunto-gun Shizuoka-ken (JP); Taichi KAWANAI, Shizuoka-shi Shizuoka-ken (JP)

(73) Assignee: TOYOTA JIDOSHA KABUSHIKI KAISHA, Toyota-shi Aichi-ken (JP)

(21) Appl. No.: 19/653,644

(22) Filed: Apr. 21, 2026

(30) Foreign Application Priority Data
Apr. 23, 2025 (JP) 2025-071119

(51) Int. Cl. B60W 50/00; B60W 30/095

(52) U.S. Cl. CPC B60W 50/0097; B60W 30/0956; B60W 2554/4026; B60W 2554/4029; B60W 2554/4041

(57) ABSTRACT

This disclosure presents a target position prediction method for moving targets detected by sensors mounted on a mobile body. The method first acquires detected information, including the target’s position, and generates a predicted distribution for a future time based on past detected data. A prediction error is then calculated by comparing the detected position at the future time with the predicted distribution. When the prediction error meets a predetermined condition, the method adjusts the predicted distribution by modifying its variance to better reflect the target’s actual behavior. This adjustment makes the prediction range narrower for highly predictable targets and wider for less predictable ones. As a result, the method provides an appropriately conservative prediction range tailored to each target, improving both safety and efficiency.

### CROSSREFERENCE TO RELATED APPLICATION

This application claims priority to Japanese Patent Application No. 2025-071119 filed on Apr. 23, 2025, the entire contents of which are incorporated by reference herein.

### TECHNICAL FIELD

The present disclosure relates to a target position prediction method executed by a computer.

### BACKGROUND ART

Patent Literature 1 discloses a prediction device that predicts a movement area of a moving target. The prediction device obtains a normality of a moving target around a vehicle from a movement history of the moving target, and selects a movement prediction model based on the normality degree.

### List of Related Art

Patent Literature 1: Japanese Patent Application Publication No. 2010-182236.

The prior art has a feature of selecting a movement prediction model based on the movement history of the moving target. However, it does not have a feature of collating a prediction result with a measured result and reflecting (feeding back) the measured result to a prediction process.

One object of the present disclosure is to provide a technique for reflecting a measured result in a position prediction process of a moving target, thereby outputting an appropriate prediction range according to each moving target.

A first aspect relates to a target position prediction method executed by a computer.

The target position prediction method includes:
acquiring detected information including at least a detected position, which is a position of a moving target detected by a sensor mounted on a moving body;
a prediction distribution generation process for generating a predicted distribution of the position of the moving target at a second time point subsequent to a first time point, based on first detected information, which is the detected information at the first time point;
an error calculation process for calculating a prediction error between a second detected position and the predicted distribution, wherein the second detected position is the detected position of the moving target at the second time point; and
a prediction distribution adjustment process for adjusting the predicted distribution generated in the prediction distribution generation process, when a predetermined condition regarding the prediction error is satisfied.

The target position prediction method according to the present disclosure adjusts the predicted distribution generated by the predicted distribution generation process based on the prediction error between the detected position and the predicted distribution. As a result, a predicted distribution that takes into account the prediction error concerning the moving target, that is, a prediction range, is acquired.

### BRIEF DESCRIPTION OF DRAWINGS

FIG. 1 is a conceptual diagram for explaining the embodiment of the present disclosure.

FIG. 2 is a block diagram illustrating an example of a functional configuration of a target position prediction system.

FIG. 3 is a flowchart illustrating a target position prediction process.

FIG. 4 is a conceptual diagram for explaining an example of a predicted distribution generation process.

FIG. 5A is a diagram schematically illustrating a prediction distribution adjustment process in the x-axis direction.

FIG. 5B is another diagram schematically illustrating a prediction distribution adjustment process in the x-axis direction.

FIG. 6A is a block diagram illustrating a predicted distribution generation process reflecting a prediction distribution adjustment process.

FIG. 6B is another block diagram illustrating a predicted distribution generation process reflecting a prediction distribution adjustment process.

### DETAILED DESCRIPTION

The embodiment of the present disclosure will be described with reference to the drawings.

### 1. OUTLINE

The technique according to the present embodiment is applied to a moving body. Examples of a moving body include vehicles, robots, and the etc. The vehicle may be an autonomous driving vehicle, or may be a vehicle driven by a driver. Examples of robots include a logistics robot, a work robot, and the etc. As one example, the following description considers the case where the moving body is a vehicle. In the case of generalization, the term "vehicle" in the following description shall be read as "moving body."

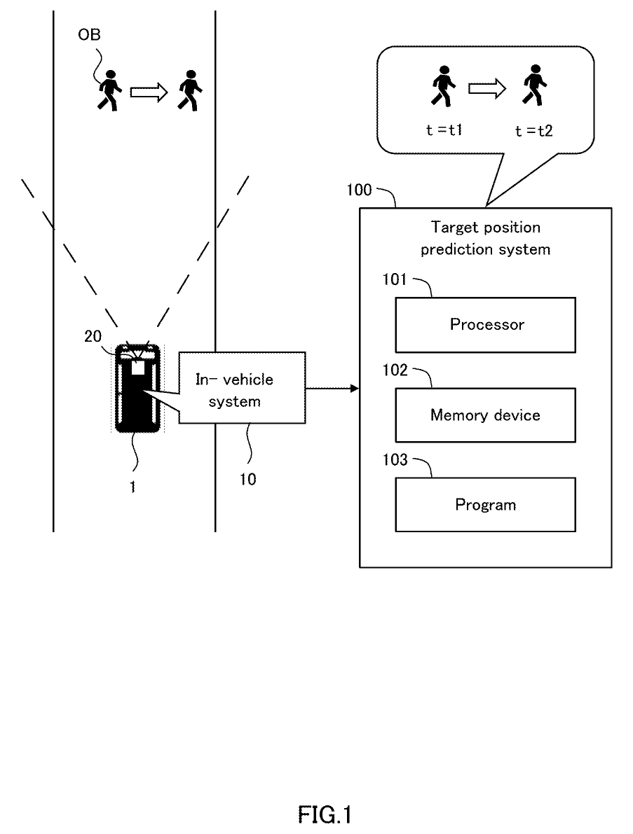

FIG. 1 is a conceptual diagram for explaining an outline according to the present embodiment. An in-vehicle system 10 is mounted on a vehicle 1 and controls the vehicle 1. The in-vehicle system 10 may be an autonomous driving system that controls autonomous driving of the vehicle 1. That is, the vehicle 1 may be an autonomous driving vehicle. Here, autonomous driving means that at least a part of steering, acceleration, and deceleration of the vehicle 1 is automatically performed independently of driver operation. As one example, autonomous driving may be at level 3 or higher.

A sensor 20 is mounted on the vehicle 1. The sensor 20 includes a recognition sensor, a vehicle state sensor, a position sensor, and the etc. The recognition sensor is used to recognize (detect) the situation around the vehicle 1. Examples of the recognition sensor include a camera, LiDAR (Light Detection and Ranging), radar, etc. The vehicle state sensor detects a state of the vehicle 1. For example, the vehicle state sensor includes a speed sensor, an acceleration sensor, a yaw rate sensor, a steering angle sensor, etc. A position sensor detects a position and an orientation of the vehicle 1. For example, the position sensor includes a GNSS (Global Navigation Satellite System) sensor.

An in-vehicle system 10 detects (recognizes) objects surrounding the vehicle 1 by using a recognition sensor. Examples of objects surrounding the vehicle 1 include a moving target OB, a white line, a landmark, a traffic signal, and the etc. The moving target OB widely includes movable objects such as pedestrians, bicycles, motorcycles, another vehicle (e.g., a preceding vehicle, a parked vehicle, etc.), etc. Object information indicates a relative position and a relative velocity of a detected object with respect to the vehicle 1. For example, an object can be identified by analyzing an image captured by a camera, and a relative position of the object can be calculated. It is also possible to identify an object and acquire a relative position and a relative velocity of the object based on point cloud information obtained by LiDAR.

In addition, the in-vehicle system 10 acquires vehicle position information indicating a current position of the vehicle 1 by using a position sensor. The in-vehicle system 10 may acquire highly accurate vehicle position information by a well-known self-position estimation process (Localization) utilizing object information and map information. Furthermore, the in-vehicle system 10 acquires vehicle state information detected by a vehicle state sensor.

The in-vehicle system 10 controls the vehicle 1 based on various information obtained by the sensor 20. For example, the in-vehicle system 10 automatically performs a risk avoidance control to avoid a moving target OB located ahead of a vehicle 1. The risk avoidance control is an example of autonomous driving control, and includes at least one of steering control and deceleration control. Specifically, the in-vehicle system 10 generates a target trajectory for avoiding a collision with a detected moving target OB. The target trajectory includes a target position and a target speed of the vehicle 1. Then, the in-vehicle system 10 performs vehicle travel control so that the vehicle 1 follows a target trajectory.

In order to safely execute vehicle control (for example, risk avoidance control) that considers the behavior of a moving target OB, in embodiments it is assumed that the moving target OB is capable of moving over a wide range. That is, vehicle control based on prediction (worst-case prediction) assuming an unlikely event is safe. However, needlessly expanding the prediction range means that vehicle control may become susceptible to extremely low-probability events. For example, there may be cases where excessively cautious decisions are made during lane change or overtaking, which may hinder smooth driving. That is, in order to appropriately execute vehicle control that takes into account the behavior of a moving target OB, it is necessary to appropriately adjust a position prediction range of the moving target.

A technique for adjusting a position prediction range of the moving target OB itself is known (for example, Patent Literature 1). A typical prior art predicts a range in which the moving target OB can move by referring to a movement history of the moving target. However, in conventional technology, the viewpoint of comparing a result of position prediction with a measured result and reflecting the result in the next position prediction has not been considered. Accordingly, the present embodiment discloses a technique for dynamically updating a movement prediction range of a moving target OB by reflecting actual measurement results in position prediction. As described above, in the present embodiment, a position prediction process having a feature of dynamically adjusting the movement prediction range of the moving target OB is referred to as 'target position prediction process.'

A target position prediction system 100 is configured to perform the target position prediction process. For example, the target position prediction system 100 is one part of the above-described in-vehicle system 10. In other words, the target position prediction system 100 may be included in the in-vehicle system 10.

As another example, the target position prediction system 100 may be disposed outside the vehicle 1. In this case, the target position prediction system 100 communicates with the vehicle 1 (in-vehicle system 10) and acquires information necessary for an error calculation process from the in-vehicle system 10. For example, the necessary information includes sensor data obtained by a sensor 20.

As a further example, the target position prediction system 100 may be distributed between an in-vehicle system 10 and an external management server.

In general, a target position prediction system 100 includes one or more processors 101 (hereinafter simply referred to as the processor 101) and one or more memory devices 102 (hereinafter simply referred to as the storage device 102). The processor 101 executes various processes including a target position prediction process. Examples of the processor 101 include a CPU (Central Processing Unit), an ASIC (Application Specific Integrated Circuit), and an FPGA (Field-Programmable Gate Array), and the like. A memory device 102 stores various types of information required for process by a processor 101. As the memory device 102, an HDD (Hard Disk Drive), an SSD (Solid State Drive), a volatile memory, a non-volatile memory, etc. are exemplified.

A program 103 is a computer program for controlling a target position prediction system 100. The function of the target position prediction system 100 may be realized by cooperation between a processor 101 that executes the program 103 and a memory device 102. The program 103 is stored in the memory device 102. The program 103 may be recorded on a computer-readable recording medium.

Hereinafter, the target position prediction process by the target position prediction system 100 according to this embodiment will be described in more detail.

### 2. TARGET POSITION PREDICTION PROCESS

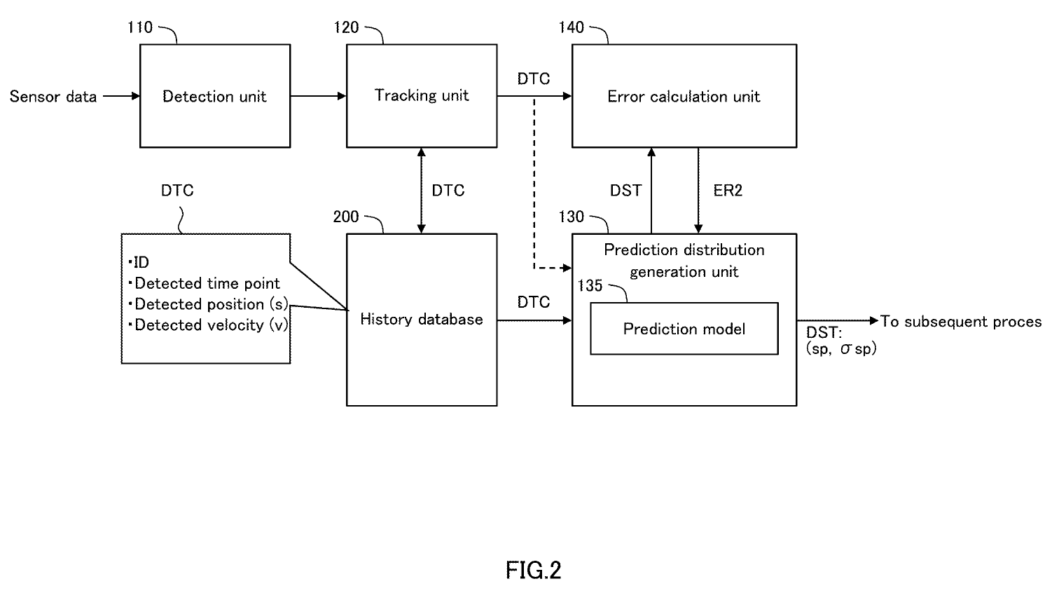

FIG. 2 is a block diagram illustrating an example configuration of the target position prediction system 100 according to an embodiment of the present disclosure. The target position prediction system 100 comprises, as functional blocks, a detection unit 110, a tracking unit 120, a prediction distribution generation unit 130, and an error calculation unit 140. These functional blocks are realized through collaboration between the processor 101 and the memory device 102. Further, the target position prediction system 100 includes a history database 200, which will be described later. The history database 200 is stored in the memory device 102.

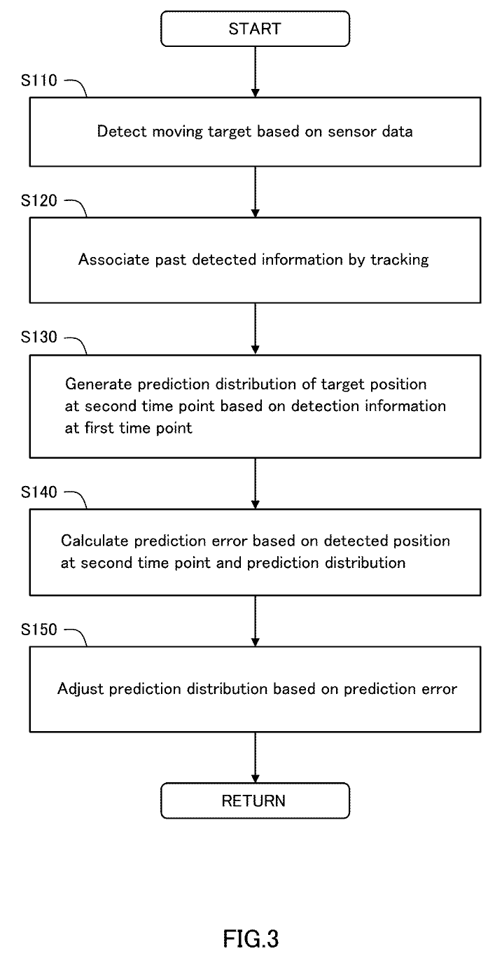

FIG. 3 is a flowchart illustrating a target position prediction process. With reference to FIGS. 2 and 3 , the target position prediction process according to the present embodiment will be described.

### 2-1. Detection process (Step S110)

The detection unit 110 detects the moving target OB around the vehicle 1 based on sensor data obtained by the sensor 20 (recognition sensor) mounted on the vehicle 1.

### 2-2. Tracking process (Step S120)

The tracking unit 120 performs tracking of the moving target OB detected by the detection unit 110. By this tracking process, a currently detected moving target OB is associated with the same moving target OB previously detected. In other words, the same moving target OBs detected at different timings are associated with each other. The tracking process is a well-known technique, and its method is not particularly limited. For example, a machine learning-based tracking algorithm is used.

Detected information DTC is information relating to the detected moving target OB. For example, the detected information DTC includes identification information (ID), detection time, detected position s, and detected speed v.

Identification information is information for identifying the same moving target OB. The same identification information is assigned to the same moving target OB, and different identification information is assigned to different moving target. For example, a track ID assigned to the same moving target OB in a tracking process may be used as identification information for the moving target OB.

A detection time is the time (process cycle) at which the moving target OB is detected. The detection time is obtained from the detection unit 110 or the tracking unit 120.

A detected position s is a position of the moving target OB in the absolute coordinate system. A relative position of the moving target OB with respect to the vehicle 1 is obtained by the detection unit 110. The position of the vehicle 1 in the absolute coordinate system is obtained from the above-described vehicle position information.

A detected velocity v is a velocity of the moving target OB in the absolute coordinate system. A relative velocity of the moving target OB with respect to the vehicle 1 is obtained by the detection unit 110 or the tracking unit 120. The speed and traveling direction of the vehicle 1 in the absolute coordinate system are obtained from the above-mentioned vehicle position information and vehicle state information. By combining the relative velocity of the moving target OB with the speed and traveling direction of the vehicle 1 in the absolute coordinate system, it is possible to calculate the detected speed v of the moving target in the absolute coordinate system. The detected speed v is data that also includes information concerning the traveling direction of the moving target OB.

In addition to the parameter listed herein, the detected information DTC may also include the acceleration, jerk, yaw rate, etc. of a moving target OB. In other words, the detected information DTC broadly includes parameter (motion parameter) that indicates the motion state of the moving target OB.

The history database 200 is a database of detected information DTC obtained in the past. When the tracking unit 120 acquires new detected information DTC through a tracking process, the tracking unit 120 registers the detected information DTC in the history database 200. In a next process cycle, the tracking unit 120 receives a latest detection result regarding a moving target OB from the detection unit 110. Upon receiving the latest detection result, the tracking unit 120 performs a tracking process based on past detected information DTC registered in the history database 200. As a result of the tracking process, the currently detected moving target OB is associated with the same moving target OB detected in the previous detection.

In this manner, the detected information DTC related to the same moving target OB is gradually accumulated in the history database 200. The history accumulated for a certain moving target OB can also be regarded as a trajectory of the moving target OB.

### 2-3. Predicted Distribution Generation Process (Step S130)

The prediction distribution generation unit 130 predicts the position of the moving target OB based on past detected information DTC registered in the history database 200. According to one embodiment, the predicted position of the moving target OB is represented by a probabilistic distribution (probability density function). Hereinafter, a distribution of the predicted position of the moving target OB is referred to as a "predicted distribution DST." The prediction distribution generation unit 130 performs a prediction distribution generation process that generates a predicted distribution DST of the moving target OB based on the history database 200. The predicted distribution DST is, for example, a normal distribution (Gaussian distribution). Since the probability density function indicating the predicted distribution DST is a function for predicting a behavior of the target, it may also be referred to as a behavior prediction function. A predicted distribution DST is represented as a combination of a predicted position sp and a predicted deviation σsp.

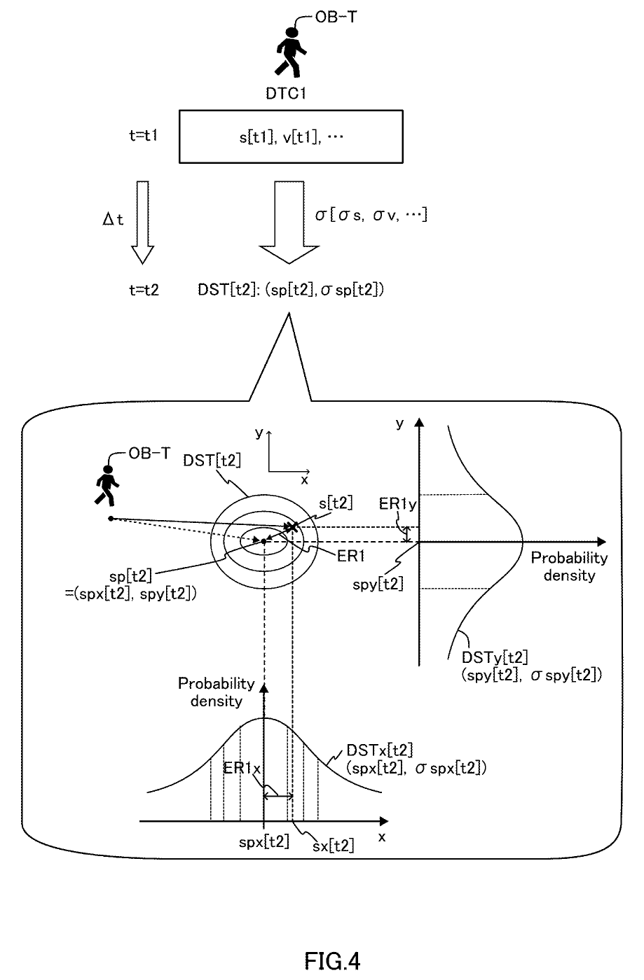

FIG. 4 is a conceptual diagram for explaining an example of the prediction distribution generation process. For convenience, in the following explanation, two time points, "a first time point t1" and "a second time point t2," are considered. The first time point t1 is a time prior to the second time point t2, and the second time point t2 is a time subsequent to the first time point t1. The elapsed time Δt is the period between the first time point t1 and the second time point t2. Further, in the following description, "the target OB-T" refers to a moving target OB, which is the subject for which the predicted distribution DST is generated. For example, the second time point t2 is a detection time indicated by the latest detected information DTC, and the target OB-T is the moving target OB specified by identification information indicated by the latest detected information DTC. The information indicated by the latest detected information DTC is notified from the tracking unit 120 to the prediction distribution generation unit 130.

First detected information DTC1 is detected information DTC regarding the target OB-T at the first time point t1 (detected time). The first detected information DTC1 includes the detected position s[t1] and the detection velocity v[t1] of the target OB-T at the first time point t1, etc.

The prediction distribution generation unit 130 acquires the first detected information DTC1 from the history database 200 and, based on the first detected information DTC1, generates a predicted distribution DST[t2] for predicting the position of the target OB-T at the second time point t2.

The prediction distribution generation unit 130 generates the predicted distribution DST[t2] at the second time point t2 based on the first detected information DTC1 and a deviation parameter σ. The deviation parameter σ indicates the degree of deviation applied to the first detected information DTC1 for prediction. The deviation parameter σ includes values corresponding to respective items of the first detected information DTC1, etc. as a position deviation parameter σs indicating the deviation in position, and a velocity deviation parameter σv indicating the deviation in velocity.

The predicted distribution DST[t2] at the second time point t2 is defined by a combination of a predicted position sp[t2] and a predicted deviation σsp[t2] of the target OB-T. The predicted position sp[t2] is the mode (peak value of the distribution) of the predicted distribution DST[t2]. The predicted deviation σsp[t2] is a parameter that represents the shape of the predicted distribution DST[t2] based on the variation from the predicted position sp[t2] of the target OB-T. When the predicted distribution DST[t2] is generated as a normal distribution, the predicted position sp[t2] is represented as a mean value, and the predicted deviation σsp[t2] is represented as a standard deviation. That is, the predicted distribution DST[t2] can be represented as N(sp[t2], σsp[t2]²). σsp[t2]² represents the variance of the predicted distribution DST[t2].

The lower part of FIG. 4 illustrates an example of the predicted distribution DST[t2] obtained as a normal distribution. The central position of the predicted distribution DST[t2] is the predicted position sp[t2]. The predicted distribution DST[t2] has a spread corresponding to the predicted deviation σsp[t2]. That is, the predicted distribution DST[t2] indicates that the closer a region is to the predicted position sp[t2], which is the center, the higher the possibility that the target OB-T is located there, and conversely, the farther a region is from the predicted position sp[t2], the lower the possibility that the target OB-T is located there. The x-axis and the y-axis in the figure represent axes of a ground surface (road surface) and are mutually orthogonal.

Hereinafter, for the sake of simplicity, a description is given focusing on the x-axis direction of the predicted distribution DST[t2]. The predicted distribution DSTx[t2] in the x-axis direction of the predicted distribution DST[t2] is represented by the predicted position spx[t2] and the predicted deviation σspx{t2]. A large value of the predicted deviation σspx[t2] means that a predetermined confidence interval (for example, a 99% confidence interval) becomes wider, and it predicts that the target OB-T may appear over a wide area centered on the predicted position spx[t2]. On the other hand, a small value of the predicted deviation σspx[t2] means that the predetermined confidence interval becomes narrower, and this predicts that a target OB-T may appear within a narrow range centered on the predicted position spx[t2]. Incidentally, this explanation is also applicable to the y-axis direction. The predicted distribution DSTy[t2] in the y-axis direction of the predicted distribution DST[t2] is represented by the predicted position spy[t2] and the predicted dispersion σspy[t2].

The prediction distribution generation unit 130 retains one or a plurality of prediction model 135 (hereinafter simply referred to as "the prediction model 135") (see FIG. 2). The prediction model 135 is configured to generate the predicted distribution DST[t2] by outputting the predicted position sp[t2] and the predicted parameter σsp[t2], taking as inputs the first detected information DTC1, the elapsed time Δt, and the deviation parameter σ. The prediction model 135 may be provided by a mathematical expression or may be provided by a machine learning model.

The prediction distribution generation unit 130 may correct a predicted distribution DST[t2] in consideration of a type of the target OB-T. For example, it is considered that a vehicle travels along a lane without straying from the lane. Therefore, in a case where the target OB-T is a vehicle, after generating the predicted distribution DST[t2], the prediction distribution generation unit 130 may correct the predicted distribution DST[t2] so as to follow the lane without departing from the lane.

The prediction distribution generation unit 130 may generate a predicted distribution DST[t2] for various elapsed times Δt by variously changing the first time point t1.

### 2-4. Error Calculation Process (Step S140)

The error calculation unit 140 calculates an error between the predicted distribution DST[t2] of the target OB-T and the second detected position s[t2] (error calculation process). The second detected position s[t2] is the detected position s of the target OB-T at the second time point t2.

More specifically, the error calculation unit 140 acquires the predicted distribution DST[t2] generated by the prediction distribution generation unit 130 and the second detected position s[t2]. The second detected position s[t2] is included in the detected information DTC relating to the target OB-T at the second time point t2. For example, the error calculation unit 140 acquires detected information DTC regarding the target OB-T at the second time point t2 from the tracking unit 120. That is, the second detected position s[t2] is the measured position of the target OB-T at the second time point t2. Then, the error calculation unit 140 calculates an error of the predicted distribution DST[t2] by comparing the second detected position s[t2] of the target OB-T with the predicted distribution DST[t2]. This error is represented by the distance between the second detected position s[t2] and the predicted position sp[t2], and is hereinafter referred to as a simple error ER1. The simple error ER1 can be decomposed into an x-axis component (referred to as simple error ER1x) and a y-axis component (referred to as simple error ER1y).

The lower part of FIG. 4 describes an error calculation process regarding the simple error ER1x of the predicted distribution DSTx[t2], assuming that the second detected position sx[t2] has been obtained for the predicted distribution DSTx[t2]. The error calculation unit 140 calculates a distance between the predicted position spx[t2] and the second detected position sx[t2] as the simple error ER1x. Typically, the simple error ER1x is expressed as a ratio to a predicted deviation σspx[t2].

The error calculation unit 140 further calculates a prediction error ER2, which is used in a prediction distribution adjustment process described later. The prediction error ER2 is typically obtained by statistically processing the simple errors ER1x over a predetermined period (e.g., average value over a predetermined period, root mean square error, etc.). A small prediction error ER2 means that the predicted distribution DST generated by the prediction model 135 can accurately predict the behavior of the target, and is therefore synonymous with a high degree of 'predictability' of the target. Conversely, a large prediction error ER2 means that the accuracy of the position prediction of a target OB-T by the predicted distribution DST generated by the prediction model 135 is low, and is synonymous with low predictability of the target OB-T.

### 2-5. Prediction Distribution Adjustment Process (Step S150)

A prediction distribution generation unit 130 adjusts the predicted distribution DST of a target OB-T generated in the predicted distribution generation process, when a predetermined condition is satisfied for the prediction error ER2. This process is referred to as a prediction distribution generation process.

Adjusting the predicted distribution DST means that the prediction distribution generation unit 130 generates a predicted distribution DST[t3] of the target OB-T at a third time point t3, which is a time later than the second time point t2, so that the predicted distribution DST[t3] is different from the predicted distribution DST[t2]. For example, the prediction distribution adjustment process includes changing a variance of the predicted distribution DST. Reducing the variance of the predicted distribution DST means that a shape of the predicted distribution DST becomes more concentrated around a vicinity of the peak value. At this time, the peak value of a probability density function increases. On the other hand, increasing the variance of the predicted distribution DST means that the shape of the predicted distribution DST becomes more gradual. At this time, the peak value of the probability density function decreases. Reducing the variance is synonymous with increasing the kurtosis of the distribution shape, and increasing the variance is synonymous with decreasing the kurtosis of the distribution shape.

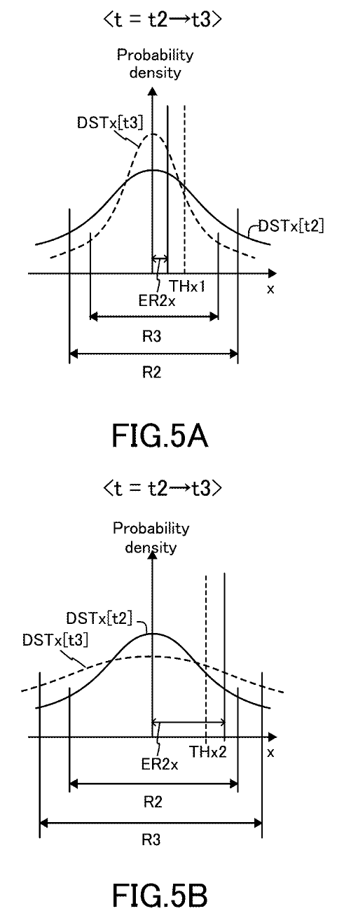

FIGS. 5A and 5B schematically illustrate the prediction distribution adjustment process in the x-axis direction. Here, it is assumed that the prediction error ER2x in the x direction is obtained by the error calculation process.

FIG. 5A illustrates the prediction distribution adjustment process to reduce the variance. The prediction distribution generation unit 130 reduces the variance of the predicted distribution DSTx[t3] to be smaller than the variance of the predicted distribution DSTx[t2] when the prediction error ER2x is less than a threshold THx1. In this case, the kurtosis of the predicted distribution DST[t3] becomes larger than that of the predicted distribution DSTx[t2]. Assuming that the "prediction range" of the predicted distribution DSTx is regarded as a predetermined confidence interval (for example, a 99% confidence interval), the prediction range R3 of the predicted distribution DSTx[t3] becomes smaller than the prediction range R2 of the predicted distribution DSTx[t2]. This means that a prediction with a narrower prediction range is executed for a highly predictable target OB-T, which is reasonable.

FIG. 5B illustrates a predicted distribution process to increase the variance. The prediction distribution generation unit 130 increases the variance of the predicted distribution DSTx[t3] to be greater than the variance of the predicted distribution DSTx[t2] when a prediction error ER2x is greater than a threshold THx2. In this case, the shape of the predicted distribution DST[t3] becomes a more moderate shape (lower kurtosis) than the predicted distribution DSTx[t2]. In this case, the prediction range R3 of the predicted distribution DSTx[t3] becomes larger than the prediction range R2 of the predicted distribution DSTx[t2]. This is reasonable because it means that a prediction with a wide prediction range is executed for a target OB-T having low predictability.

The prediction distribution generation unit 130 may adjust the variance so that the prediction error ER2 falls within a predetermined range. The predetermined range is determined based on the predicted deviation (for example, standard deviation) of the predicted distribution DST[t3] after the prediction distribution adjustment process. For example, in the case where the prediction distribution adjustment process is a process that reduces the variance, the prediction distribution generation unit 130 sets the variance of the predicted distribution DST[t3] so as to satisfy the condition that the prediction error ER2 falls within a range of 0.5 to 1 times the prediction variance. This prevents the variance from being limitlessly small. For example, when the prediction distribution adjustment process is a process to increase the variance, the prediction distribution generation unit 130 sets the variance of the predicted distribution DST[t3] such that the prediction error ER2 falls within a range of two to three times the prediction variance. This prevents the variance from being limitlessly large.

### 2-6. Predicted Distribution Generation Process Reflecting Prediction Distribution Adjustment Process

The prediction distribution generation unit 130 generates the predicted distribution DST[t3] for predicting the position of the target OB-T at the third time point t3 by utilizing the result of the prediction distribution adjustment process. In other words, the result of the prediction distribution adjustment process is fed back to the prediction distribution generation process. The prediction distribution generation process that reflects the prediction distribution adjustment process is executed by switching between a plurality of prediction model 135 or by adjusting parameter of a single prediction model 135.

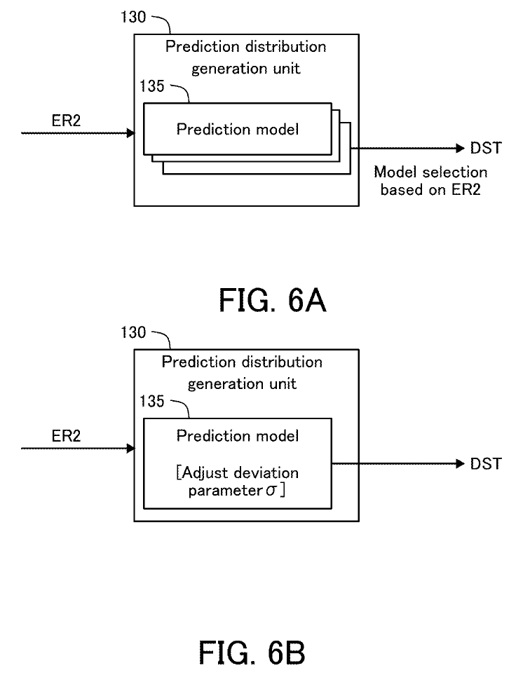

FIGS. 6A and 6B are functional block diagrams illustrating the prediction distribution generation process reflecting the prediction distribution adjustment process. FIG. 6A shows a case in which the prediction distribution generation unit 130 includes a plurality of prediction model 135. In this case, the prediction distribution generation unit 130 selects a model to actually use from among the plurality of prediction model 135 in accordance with the prediction error ER2. These models include, for example, a first model in which the deviation parameter σ is relatively small, a second model in which the deviation parameter σ is relatively large, and a third model in which the deviation parameter σ is of an intermediate value. For example, when the prediction distribution generation unit 130 determines that the prediction error ER2 is smaller than a first threshold, the first model is selected, and when the prediction error ER2 is larger than a second threshold, the second model is selected. Accordingly, an appropriate model is selected in accordance with the prediction error ER2 with respect to the target OB-T. This means that the prediction distribution generation unit 130 generates the predicted distribution DST[t3] having an appropriate variance in accordance with the prediction error ER2 of the target OB-T. When the prediction distribution generation unit 130 executes the predicted distribution generation process for the first time for a certain target OB-T, it uses a third model in which the deviation parameter σ is of medium value. Typically, a third model represents a model that outputs average behavior of a category to which the target OB-T belongs (e.g., general pedestrian, general vehicle, etc.).

FIG. 6B shows a case in which the prediction distribution generation unit 130 comprises a single prediction model 135. In this case, prediction model 135 updates a value of a deviation parameter σ using prediction error ER2 as an input value. The update of the variance parameter σ is to vary a variance of the motion parameter. For example, when a prediction error ER2 is less than a first threshold, a prediction distribution generation unit 130 decreases the deviation parameter σ. For example, by decreasing the velocity deviation parameter σv, the variance of a generated predicted distribution DST[t3] becomes smaller. Conversely, when the prediction error ER2 is greater than a second threshold, the prediction distribution generation unit 130 increases the deviation parameter σ. For example, by increasing the velocity deviation parameter σv, a variance of the generated predicted distribution DST[t3] increases.

### 3. EFFECTS

The prediction distribution generation unit 130 generates a predicted distribution DST that reflects a prediction distribution adjustment process. This means that a predicted distribution DST having an appropriate deviation corresponding to the behavior of the target OB-T is generated. The prediction error ER2, which is used in a prediction distribution adjustment process, is calculated based on a simple error ER1 between a detected position s (that is, a measured value based on sensor data) and the predicted position sp. In summary, prediction distribution generation unit 130 generates predicted distribution DST by reflecting a deviation between a measured position and a predicted position. When the prediction error ER2 of a target OB-T is sufficiently small (that is, when the predictability is high), a prediction distribution generation unit 130 generates a predicted distribution DST with a smaller variance. As a result, the prediction range becomes narrower, making it possible to avoid excessively conservative predictions. When the prediction error ER2 of a target OB-T is too large (i.e., when predictability is low), a predicted distribution DST with a greater variance is used. As a result, the prediction range becomes wider, and more conservative predictions are made. For example, in autonomous driving control using the predicted distribution DST, a target trajectory is generated so as to avoid a predicted range, which is determined based on the predicted deviation σsp of the moving target OB (for example, twice the predicted deviation σsp). Avoiding excessively conservative predictions leads to smoother and more efficient driving. Conservative predictions lead to more prudent and safer driving.

### 4. APPLICATION EXAMPLES

The prediction distribution generation unit 130 may utilize map information. The map information includes information concerning the types of roads (sidewalk, roadway, intersection, vehicle speed restriction, presence or absence of traffic signals, etc.). The prediction distribution generation unit 130 can predict the behavior of the moving target OB more accurately by utilizing the map information. For example, it can be predicted that a pedestrian walking on a sidewalk is likely to move along the sidewalk.

The target position prediction system 100 can be applied to an intelligent transport system. For example, in the case where the predicted distributions DST of a pedestrian and a vehicle overlap at an intersection, it is possible to ensure safety by changing the traffic signal for the vehicle side to red. Alternatively, in the case where another vehicle whose predicted distribution DST overlaps exists, a message warning of such may be displayed (for example, "Attention: vehicle approaching").

The predicted distribution DST can be applied to the evaluation of driving skills. Specifically, it is possible to evaluate the degree to which a driver is operating the vehicle while taking into account contact or proximity with surrounding moving target OB. For example, the target position prediction system 100 checks whether a vehicle operating a vehicle 1 properly adjusts a speed when the vehicle travels in a region overlapping with a predicted driver distribution DST. In this manner, the driving skill can be evaluated more objectively and accurately.

What is claimed is:

1. A target position prediction method executed by a computer, the target position prediction method comprising:
acquiring detected information including at least a detected position, which is a position of a moving target detected by a sensor mounted on a moving body;
a prediction distribution generation process for generating a predicted distribution of the position of the moving target at a second time point subsequent to a first time point, based on first detected information, which is the detected information at the first time point;
an error calculation process for calculating a prediction error between a second detected position and the predicted distribution, wherein the second detected position is the detected position of the moving target at the second time point; and
a prediction distribution adjustment process for adjusting the predicted distribution generated in the prediction distribution generation process, when a predetermined condition regarding the prediction error is satisfied.

2. The target position prediction method according to claim 1, wherein
the prediction distribution adjustment process includes, when the prediction error is smaller than a first threshold, reducing a variance of the predicted distribution.

3. The target position prediction method according to claim 1, wherein
the prediction distribution adjustment process includes, when the prediction error is greater than a second threshold, increasing a variance of the predicted distribution.

4. The target position prediction method according to claim 1, wherein
the prediction distribution adjustment process includes adjusting a variance of the predicted distribution so that the prediction error falls within a predetermined range based on a standard deviation of the predicted distribution.
